(19) United States
(12) Patent Application Publication
(10) Pub. No.: US 2003/0018733 A1
(43) Pub. Date: Jan. 23, 2003

(54) System and method for controlling home appliances

(75) Inventors: Sang Chul Yoon, Kyungki-do (KR); Duck Goo Jeon, Seoul (KR)

Correspondence Address: GREENBLUM & BERNSTEIN, P.L.C., 1941 ROLAND CLARKE PLACE, RESTON, VA, 20191, US

(73) Assignee: LG ELECTRONICS, INC., Seoul (KR)

(21) Appl. No.: 10/028,426

(22) Filed: Dec. 28, 2001

(30) Foreign Application Priority Data
Jul. 20, 2001 (KR) 2001-43714

(51) Int. Cl. G06F 15/16

(52) U.S. Cl. 709/208

(57) ABSTRACT

A system and method for controlling a plurality of home appliances installed in a building. A computing device is provided to set respective private IP addresses of the home appliances to connect the appliances to an internal Internet network equipped with a LAN line installed previously in the building, and communication modules are provided to store the set private IP addresses and convert/process information transmitted and received between the home appliances and the internet network appropriately to standards of the appliances and Internet network. An integrated network control process can be performed with respect to the home appliances with no use of high-price LAN cards or CPUs by simply installing the communication modules in the existing appliance constructions. Further, an integrated home appliance/network control system can be constructed at a reduced cost to simply control the plurality of home appliances.

### BACKGROUND OF THE INVENTION

1. Field of the Invention

The present invention relates to a system and method for controlling home appliances, and more particularly to a system and method for controlling a plurality of home appliances installed in a building through the Internet.

2. Description of the Related Art

A home appliance networking system has recently been highlighted in which a plurality of home appliances are interconnected via an internal network of a home and the internal network is connected to an external Internet network, thereby enabling a user to control the home appliances from anywhere inside and outside of the home.

In the home appliance networking system, particularly, the user can not only recognize state information of a specific home appliance at any place inside of the home, but also control the specific home appliance using control means, such as a computer, at any place outside of the home. In this regard, the home appliance networking system has obtained favorable responses from many consumers, and thus has become more widespread in its application day by day.

However, the above-mentioned home appliance networking system has a disadvantage in that a local area network (LAN) must be constructed in the home or building to interconnect the home appliances via the internal network of the home and integratedly control the interconnected appliances, resulting in a great cost being incurred.

Further, in order to connect the home appliances to the internal network of the home and transmit and receive control and state information between the home appliances and the internal network, a high-price LAN card and a communication processable central processing unit (CPU) of the personal computer (PC) class must be installed in each of the home appliances.

However, it is the current reality that the installation of the LAN cards and PC-class CPUs in the respective home appliances raises manufacturing costs of the respective appliances, causing a reduction in their competitiveness on markets. Moreover, new production lines are required to install PC-class CPUs and LAN cards of new models in the home appliances. As a result, costs required for construction of the new production lines raise the prices of the home appliances still more.

Furthermore, the installation of the LAN cards and PC-class CPUs in the respective home appliances increases the costs of certain ones of the appliances not requiring the control through the internal network, and in turn results in wasting of resources.

### SUMMARY OF THE INVENTION

Therefore, the present invention has been made in view of the above problems, and it is an object of the present invention to provide a system and method for controlling home appliances wherein the home appliances are connected to a network equipped with a LAN line installed previously in a home or building, and a communication module is installed in each of the appliances to transmit and receive information between the corresponding appliance and the network, thereby enabling the appliances to be integratedly controlled reliably and economically.

In accordance with one aspect of the present invention, the above and other objects can be accomplished by the provision of a home appliance control system comprising an external Internet network installed outside of a building; an internal Internet network installed inside of the building and connected to the external Internet network via networking equipment; a plurality of home appliances installed in the building; a computing device for setting respective private Internet protocol (IP) addresses of the home appliances such that the appliances are connected to the internal Internet network on the basis of the set private IP addresses; and a plurality of communication modules installed respectively in the home appliances, each of the communication modules storing the private IP address of a corresponding one of the home appliances, set by the computing device, and processing data transmitted and received between the internal Internet network and the corresponding home appliance appropriately to standards of the internal Internet network and the corresponding home appliance.

In accordance with another aspect of the present invention, there is provided a method for controlling home appliances, comprising the steps of a) installing a plurality of communication modules in the home appliances, respectively, each of the communication modules storing a set private IP address of a corresponding one of the home appliances and processing data transmitted and received between an internal Internet network of a building in which the home appliances are installed and the corresponding home appliance appropriately to standards of the internal Internet network and the corresponding home appliance; b) setting the private IP addresses of the home appliances, respectively; and c) controlling each of the home appliances with the set private IP addresses through a user interface appropriate to the appliance control. dr

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the construction of a home appliance control system in accordance with the present invention;

FIG. 2 is a detailed block diagram of a communication module in FIG. 1;

FIG. 3 is a block diagram illustrating in detail connections of components in FIG. 1; and

FIG. 4 is a flow chart illustrating a method for controlling home appliances in accordance with the present invention.

### DESCRIPTION OF THE PREFERRED EMBODIMENTS

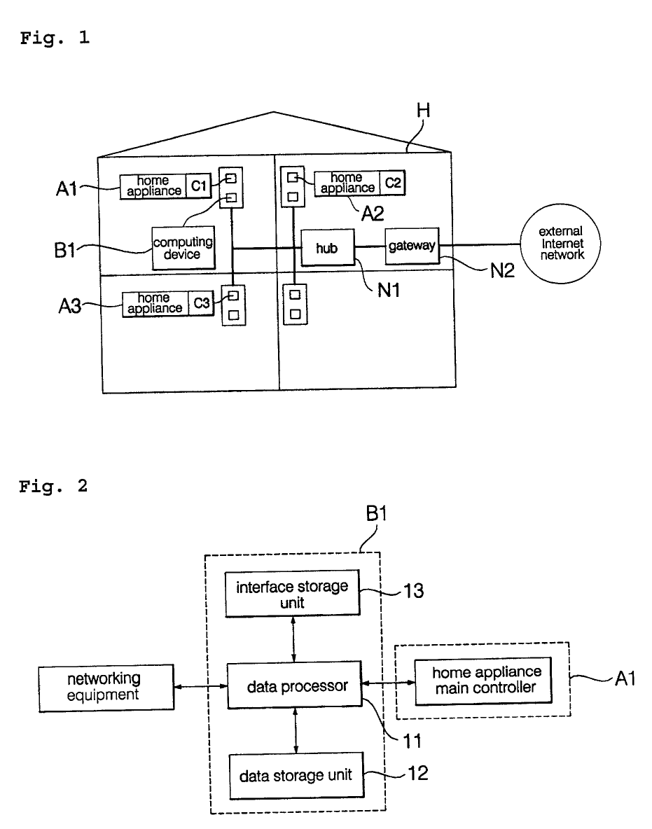

With reference to FIG. 1, there is shown in block form the construction of a home appliance control system in accordance with the present invention. As shown in this drawing, the home appliance control system comprises a plurality of home appliances A1, A2 and A3 installed to be connectable to an internal Internet network equipped with a LAN line installed previously in a home or building H, and a computing device B1 for setting respective private Internet protocol (IP) addresses of the home appliances A1, A2 and A3 and sending respective control information to the home appliances A1, A2 and A3. The computing device B1 may preferably be a PC. A plurality of communication modules C1, C2 and C3 are installed respectively in the home appliances A1, A2 and A3 to store the set private IP addresses of the corresponding appliances and process information transmitted and received between the corresponding appliances and the internal Internet network.

As seen from FIG. 1, the internal Internet network constructed in the home or building H is connected to an external Internet network via a hub N1, which is networking equipment, and a gateway N2 such that a user, when being outside of the home or building H, can gain access to the computing device B1 through the external Internet network to control the home appliances A1, A2 and A3.

The computing device B1 has a public IP address, which enables the user to access the computing device B1 when he/she is outside of the home or building H. The computing device BE1 is preferably a PC. Alternatively, the computing device B1 may be a gateway or router. In order to control the home appliances, the user or operator can enter control information to the computing device B1 directly. Alternatively, the user or operator may gain access to the computing device B1 through the external Internet network to enter the control information to the computing device B1 indirectly.

Before receiving the control information that the operator has entered directly/indirectly to control the plurality of home appliances A1, A2 and A3, the computing device B1 checks an operator identification (ID) and password entered by the operator to determine whether the operator is a person authorized to control the home appliances. The computing device B1 is adapted to prestore information about an ID and password of a valid operator in the PC. Where the ID and password entered by the operator are the same as the prestored information, the computing device B1 sends the control information entered by the operator to the respective home appliances so as to control them.

If necessary, the computing device B1 can assign respective port numbers to the home appliances A1, A2 and A3, as well as the respective private IP addresses. As a result, the plurality of home appliances A1, A2 and A3 can be controlled under the condition that one private IP address is enabled, or control information sent over the Internet can be transferred to a specific one of the home appliances A1, A2 and A3, having the same port number as well as the same private IP address, so that the sent control information can be prevented from being mistransferred or the appliances can be prevented from being controlled with erroneous control information.

The communication modules C1, C2 and C3 are installed respectively in the home appliances A1, A2 and A3. Each of the communication modules C1, C2 and C3 includes, as shown in FIG. 2, a data processor 11 for converting/processing information transmitted and received between the networking equipment and a main controller in a corresponding one of the home appliances A1, A2 and A3 appropriately to standards of the networking equipment and main controller, a data storage unit 12 for storing a private IP address and port number assigned to the corresponding home appliance as a result of the processing by the data processor 11, and an interface storage unit 13 for storing a user interface appropriate to a control and state observation of the corresponding home appliance having the private IP address stored in the data storage unit 12.

In the preferred embodiment of the present invention, the computing device B1 can simply be implemented by, in a typical PC, installing a program functioning to assign respective private IP addresses and port numbers to the home appliances. Further, each of the communication modules C1, C2 and C3 can be implemented by appending the data storage unit 12, which stores a private IP address and port number assigned by the computing device B1, to the structure of a typical communication module for a communication function of a home appliance in a field to which the present invention is applied.

The data processor 11 is adapted to process control information sent over the Internet in such a manner that it compares a private IP address and port number contained in the sent control information with the set private IP address and port number of the corresponding home appliance stored in the data storage unit 12 and transfers the sent control information to the corresponding home appliance only when it is determined to be valid as a result of the comparison.

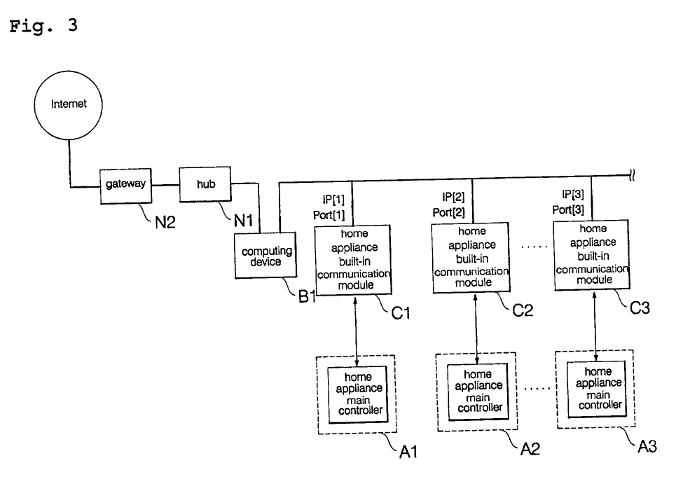

FIG. 3 shows connections of the computing device and home appliances installed in the building according to the present invention.

Referring to FIG. 3, the computing device B1 is connected to the external Internet network via the hub N1 and gateway N2. The computing device B1 has a public IP address so that it can act as a server on the external Internet network. The home appliance user or operator can gain access to the computing device B1 via the external Internet network.

The computing device B1 is also connected to the communication modules C1, C2 and C3 in the plurality of home appliances A1, A2 and A3 installed in the building through the LAN line installed previously in the building, such that respective control information are transferred to the communication modules C1, C2 and C3 through the computing device B1 so as to control the respective home appliances A1, A2 and A3.

The home appliances A1, A2 and A3 are assigned their unique private IP addresses and port numbers from the computing device B1, which are then stored in the corresponding communication modules C1, C2 and C3, respectively. As a result, each of the home appliances A1, A2 and A3 is controlled on the basis of control information only when the control information has the private IP address and port number stored in the corresponding communication module C1, C2 or C3.

The interface storage unit 13 provided in each of the communication modules C1, C2 and C3 stores a user interface appropriate to the control of a home appliance equipped with the corresponding communication module. Therefore, a program or Java script constituting a user interface of a specific home appliance is executable in the computing device or external Internet network so that the home appliance can be controlled according to the user interface through the computing device or external Internet network.

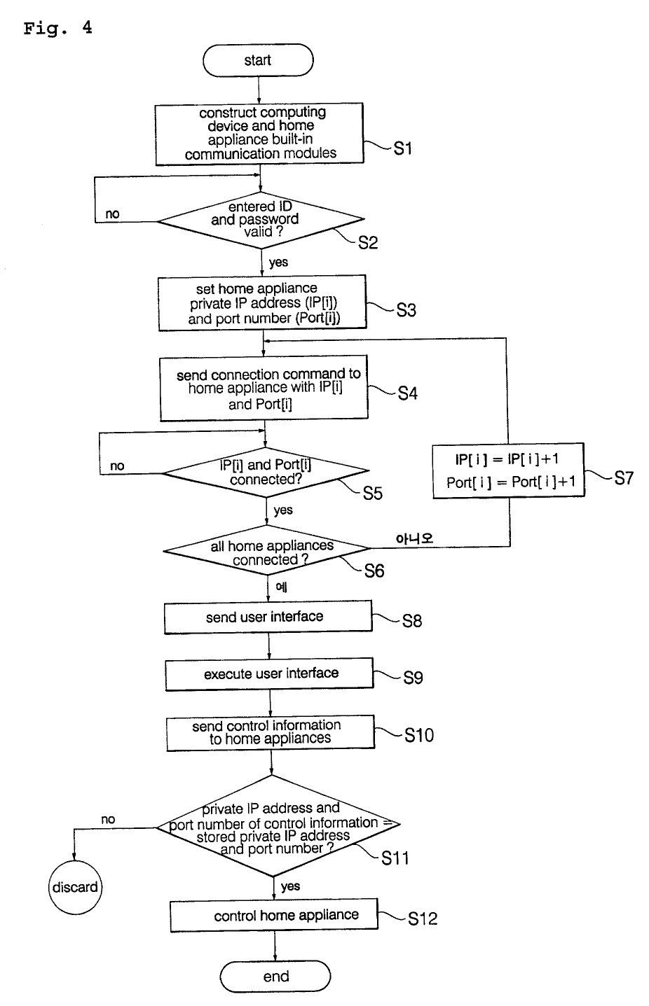

A detailed description will hereinafter be given of the operation of the home appliance control system with the above-stated construction in accordance with the present invention with reference to FIG. 4.

FIG. 4 is a flow chart illustrating a method for controlling home appliances in accordance with the present invention. First, at the first step S1, the computing device and communication modules are constructed to be interoperable with the home appliances installed in the building.

At the second step S2, the computing device checks an ID and password entered directly by the home appliance operator or indirectly over the external Internet network on the basis of the public IP address, to determine whether the operator is a person authorized to control the home appliances.

At the third step S3, if it is determined at the second step S2 that the operator is the person authorized to control the home appliances, the computing device assigns private IP addresses and port numbers to the plurality of home appliances, respectively. The communication modules in the home appliances store the assigned private IP addresses and port numbers in the data storage units, respectively. Alternatively, the computing device may store the assigned private IP addresses and port numbers by home appliances to send information to the home appliances. In this case, the computing device can dually check the assigned private IP addresses and port numbers such that the information can accurately be sent to the home appliances, respectively.

At the fourth step S4, the computing device sends a connection command to a specific home appliance with a private IP address i and port number i such that the specific home appliance is controllable through the Internet.

At the fifth step S5, the computing device determines whether the specific home appliance has been connected to the Internet in response to the connection command.

At the sixth step S6, after determining at the fifth step S5 that the specific home appliance has been connected to the Internet, the computing device determines whether all the home appliances have been connected to the Internet. On the other hand, upon determining at the fifth step S5 that the specific home appliance has not been connected to the Internet, the computing device continuously determines whether the specific home appliance has been connected to the Internet.

At the seventh step S7, if it is determined at the sixth step S6 that all of the home appliances have not been connected to the Internet, the computing device increments the private IP address i and port number i by ones, respectively, and then returns to the fourth step S4. Consequently, the computing device sends the connection command to a home appliance having a private IP address i+1 and port number i+1.

At the eighth step S8, if the plurality of home appliances installed in the building are connected to the Internet on the basis of the assigned private IP addresses and port numbers, then each of the communication modules in the home appliances sends a user interface appropriate to a control and state observation of the corresponding home appliance from the data storage unit to the computing device. Provided that the home appliance operator has entered the ID and password to the computing device indirectly through the external Internet network, the communication module sends the user interface to the operator over the Internet. As a result, the user interface is sent to an external PC or Internet connection means in the external Internet network that the operator utilizes to enter the ID and password to the computing device.

At the ninth step S9, the user interface sent at the eighth step S8 is executed in the computing device.

At the tenth step S10, home appliance control information generated according to the user interface executed at the ninth step S9 is sent to a corresponding one of the plurality of home appliances installed in the building.

At the eleventh step S11, the corresponding home appliance receives the control information sent at the above control information sending step through the associated communication module and then determines whether a private IP address and port number contained in the received control information are the same as the private IP address and port number stored in the data storage unit.

At the twelfth step S12, if it is determined at the eleventh step S11 that the private IP address and port number of the received control information are the same as the stored private IP address and port number, the corresponding home appliance is controlled on the basis of the control information. On the contrary, in the case where it is determined at the eleventh step S11 that the private IP address and port number of the received control information are not the same as the stored private IP address and port number, the corresponding home appliance discards the received control information.

As apparent from the above description, the present invention provides a system and method for controlling a plurality of home appliances installed in a building, wherein a computing device is provided to set respective private IP addresses of the home appliances to connect the appliances to an internal Internet network equipped with a LAN line installed previously in the building, and communication modules are provided to store the set private IP addresses and convert/process information transmitted and received between the home appliances and the internet network appropriately to standards of the appliances and Internet network. An integrated network control process can be performed with respect to the home appliances with no use of high-price LAN cards or CPUs by simply installing the communication modules in the existing appliance constructions. Further, an integrated home appliance/network control system can be constructed at a reduced cost to simply control the plurality of home appliances.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

The present disclosure relates to subject matter contained in priority Korean Patent Application No. 2001-43714, filed on Jul. 20, 2001, the contents of which is herein expressly incorporated by reference in its entirety.

What is claimed is:

1. A home appliance control system comprising:
an external Internet network installed outside of a building;
an internal Internet network installed inside of the building and connected to said external Internet network via networking equipment;
a plurality of home appliances installed in the building;
a computing device for setting respective private Internet protocol (IP) addresses of said home appliances such that said appliances are connected to said internal Internet network on the basis of the set private IP addresses; and
a plurality of communication modules installed respectively in said home appliances, each of said communication modules storing the private IP address of a corresponding one of said home appliances, set by said computing device, and processing data transmitted and received between said internal Internet network and said corresponding home appliance appropriately to standards of said internal Internet network and said corresponding home appliance.

2. The home appliance control system as set forth in claim 1, wherein said computing device has a public IP address for enabling access from said external Internet network.

3. The home appliance control system as set forth in claim 1, wherein each of said communication modules includes:
a data storage unit for storing the set private IP address of said corresponding home appliance;
an interface storage unit for storing a user interface appropriate to a control and state observation of said corresponding home appliance having said private IP address stored in said data storage unit; and
a data processor for converting/processing data transmitted and received between said internal Internet network and a main controller of said corresponding home appliance appropriately to standards of said internal Internet network and main controller.

4. The home appliance control system as set forth in claim 3, wherein said user interface stored in said interface storage unit is configured to be sent to said computing device such that a user controls said corresponding home appliance through said computing device.

5. The home appliance control system as set forth in claim 4, wherein said user interface stored in said interface storage unit includes a Java program executable in said computing device.

6. The home appliance control system as set forth in claim 4, wherein said user interface stored in said interface storage unit includes a Java program executable in a personal computer of the user when said user gains access to said computing device through said external Internet network.

7. A method for controlling home appliances, comprising the steps of:
a) installing a plurality of communication modules in the home appliances, respectively, each of said communication modules storing a set private IP address of a corresponding one of said home appliances and processing data transmitted and received between an internal Internet network of a building in which said home appliances are installed and said corresponding home appliance appropriately to standards of said internal Internet network and said corresponding home appliance;
b) setting the private IP addresses of said home appliances, respectively; and
c) controlling each of said home appliances with the set private IP addresses through a user interface appropriate to the appliance control.

8. The method as set forth in claim 7, further comprising the step of:
d) if a user desires to gain access to a specific one of said home appliances to control it, determining whether the user has a code valid to control the specific home appliance;
whereby said step c) is performed only when said user has the valid code.

9. The method as set forth in claim 7, further comprising the steps of:
d) connecting said home appliances to said internal Internet network if the private IP addresses of said home appliances are set at said step b); and
e) determining whether each of said home appliances has been connected to said internal Internet network.

10. The method as set forth in claim 7, wherein said step c) includes the step of:
c-1) storing said user interface appropriate to the appliance control in each of said home appliances and sending the stored user interface to a user desiring the appliance control such that it is executed by the user.

11. The method as set forth in claim 10, wherein said step c) further includes the steps of:
c-2) determining whether a private IP address contained in home appliance control information inputted through said user interface is the same as the set private IP address of each of said home appliances;
c-3) transferring a user's control command inputted through said user interface to a specific one of said home appliances if the private IP address of said control information is the same as the set private IP address of the specific home appliance; and
c-4) controlling only said specific home appliance in response to the transferred control command.
